(19) United States
(12) Patent Application Publication
(10) Pub. No.: US 2008/0204509 A1
(43) Pub. Date: Aug. 28, 2008

(54) Droplet Deposition Apparatus

(76) Inventor: Paul Raymond Drury, Hertfordshire (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/995,083

(22) PCT Filed: Jul. 11, 2006
(86) PCT No.: PCT/GB2006/002551

§ 371 Date: Mar. 19, 2008

(30) Foreign Application Priority Data
Jul. 11, 2005 (GB) 0514202.1

(51) Int. Cl. B41J 2/135

(52) U.S. Cl. 347/44

(57) ABSTRACT

An ink jet printhead has a first array of actuable side walls defining channels, the actuable sidewalls being displaceable to cause a pressure change in selected channels, alternate channels in the array being firing channels; and a second array of parallel side walls offset in a channel height direction to define channel extension regions opening to a respective firing channel. A nozzle communicates with each channel extension region. The spacing between adjacent side walls in the second array is large to reduce impedance and the spacing between adjacent actuable side walls in the first array is small to provide for efficient actuation.

The present invention relates droplet deposition apparatus and in an important example to ink jet print heads and, in particular, drop on demand ink jet print heads.

In a known construction, described for example in EP-B-0 278 590, channels are formed in a body of piezoelectric material and droplets of ink ejected, through the action of an acoustic wave in the ink channel, generated by deflection of the channel walls. Such a wall-actuated structure advantageously allows compact channel spacing and therefore a narrow nozzle pitch. A complication with such a shared wall construction is that actuation of a selected channel by wall displacement can cause pressure changes also in neighbouring channels—so called ‘cross talk’. It has been proposed to address this complication by using only every other channel for droplet ejection, however this has the effect of increasing the nozzle pitch.

In EP-B-0 278 590 it is proposed to extend alternate channels in the array in opposite directions, the extended regions allowing a degree of pressure communication between channels separated by an intermediate channel. By an appropriate choice of dimensions, this arrangement affords a method for firing all channels with reduced cross talk.

According to a first aspect of the invention there is provided droplet deposition apparatus comprising an array of channels extending in a channel array direction, said channels extending in a channel length direction, wherein alternate channels in the array are displaced in an ink ejection direction orthogonal to the channel length direction and the array direction such that a first subset of said channels have top surfaces lying in an ink ejection plane perpendicular to the ink ejection direction, communicate with a droplet ejection nozzle in the ink ejection plane and are firing channels, and a second subset of said channels are spaced apart from said ink ejection plane and are non-firing channels, said first and second subsets of channels being separated by actuable sidewalls which are displaceable in the array direction to cause a pressure change in a selected channel thereby to effect droplet deposition from a selected ejection nozzle.

The top surfaces of the firing channels are preferably wider in the array direction than the bottom surfaces of the firing channels and a step is preferably formed in sidewall surfaces abutting the firing channels to define for each firing channel an upper channel region, a lower channel region and a step surface, preferably substantially parallel to the ink ejection plane, the upper channel region being wider than the lower channel region in the array direction.

Advantageously, the firing channels are substantially T-shaped or L-shaped in cross section.

Suitably, the walls separating said upper channel portions of said first subset of channels are non-actuable.

In another aspect, the present invention consists in droplet deposition apparatus comprising: a first array of actuable side walls extending in an array direction to define therebetween respective channels, said side walls and said channels extending in a channel length direction, the actuable sidewalls being displaceable in the array direction to cause a pressure change in selected channels, wherein alternate channels in the array are firing channels; a second array of side walls extending parallel with the first array of actuable side walls and offset with respect to the first array in a channel height direction orthogonal to the channel length direction and the array direction to define therebetween respective channel extension regions, each channel extension region opening to a respective firing channel; a droplet ejection nozzle communicating with each channel extension region, such that actuation of the two actuable side walls of a firing channel effects droplet deposition from the droplet ejection nozzle in the channel extension region of that firing channel; wherein the spacing between adjacent side walls in the second array is greater than the spacing between adjacent actuable side walls in the first array.

Preferably, each channel extension region has an aspect ratio of about two or less, and each channel region between adjacent actuable sidewalls has an aspect ratio of about five or more.

The direction of droplet ejection from the firing channel may be parallel to the length of each channel or orthogonal to the length of each channel.

Suitably, there is an electrode layer extending over a channel facing surface of side wall, a step in said sidewall forming the location for an electrically isolating break in said electrode layer.

Advantageously, the apparatus is configured for the continuous flow of droplet deposition fluid along each firing channel.

In a further aspect, the present invention consists in droplet deposition apparatus comprising an array of channels extending in a channel array direction, said channels extending in a channel length direction, wherein alternate channels in the array are displaced in a channel height direction orthogonal to the channel length direction and the array direction such that a first subset of said channels have top surfaces lying in a top plane perpendicular to the channel height direction, and a second subset of said channels are spaced apart from said top plane; said first and second subsets of channels being separated by actuable sidewalls which are displaceable in the array direction to cause a pressure change in a selected channel thereby to effect droplet deposition; and wherein a step is formed in the sidewalls of said first subset of channels defining an upper channel portion, a lower channel portion and a step surface, the upper channel portion being wider than the lower channel portion in the array direction.

Preferably, the first subset of channels are substantially T-shaped in cross section.

Alternatively, the first subset of channels are substantially L-shaped in cross section.

The invention will now be described by way of example only with reference to the accompanying drawings in which:

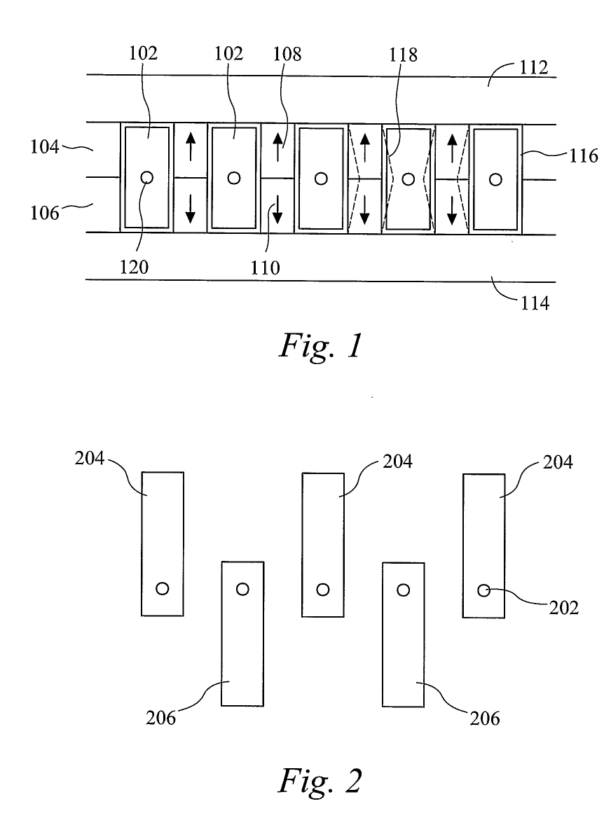

FIG. 1 shows a prior art printhead arrangement;

FIG. 2 illustrates a variation of the printhead of FIG. 1;

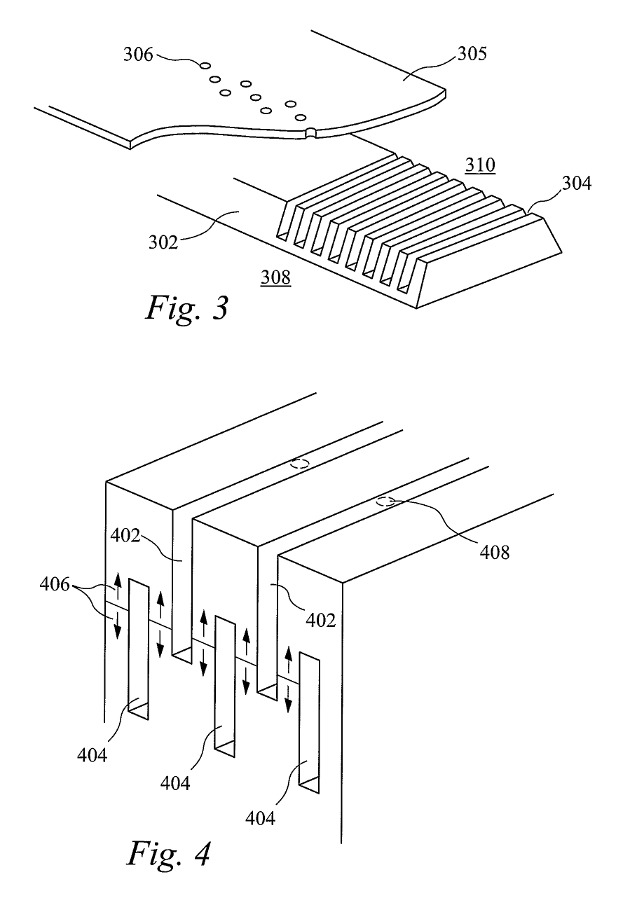

FIG. 3 shows a second prior art printhead arrangement;

FIG. 4 shows a first embodiment of the present invention;

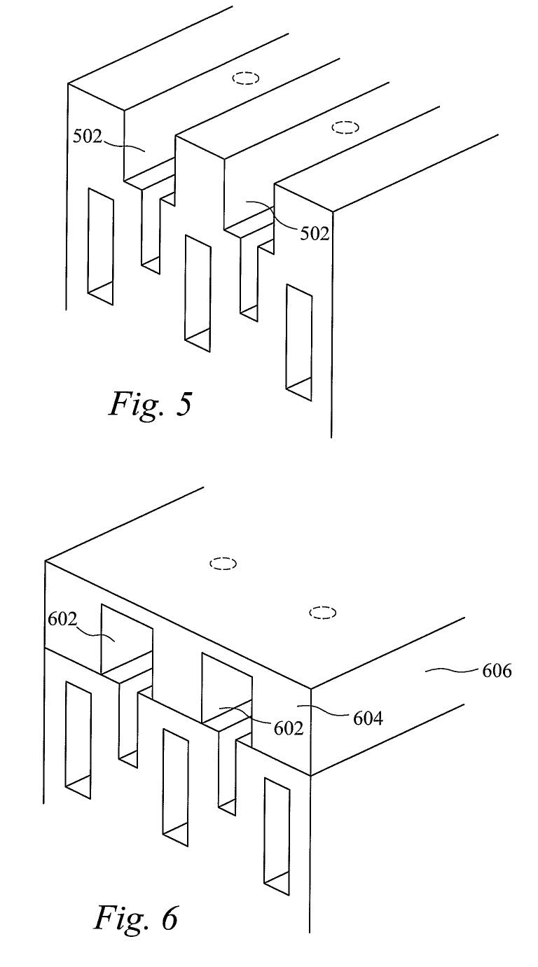

FIG. 5 shows a variation of the embodiment of FIG. 4;

FIG. 6 shows a variation of the embodiment of FIG. 5;

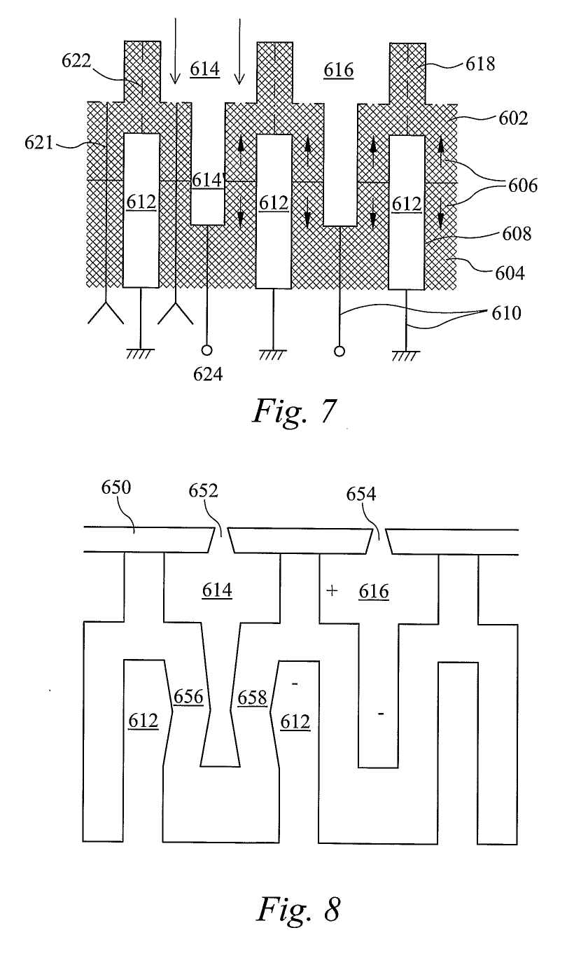

FIGS. 7 and 8 illustrate the cross section of an embodiment of the present invention;

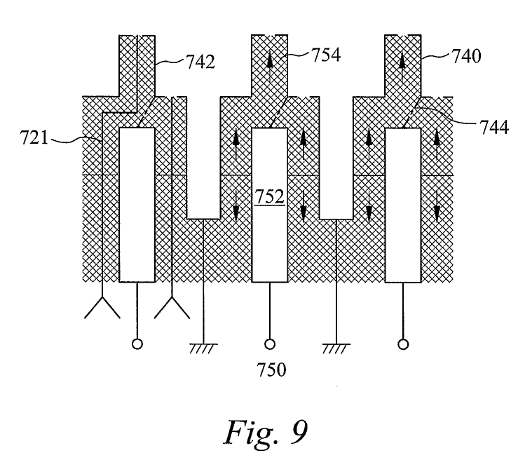

FIG. 9 illustrates an alternative electrode patterning;

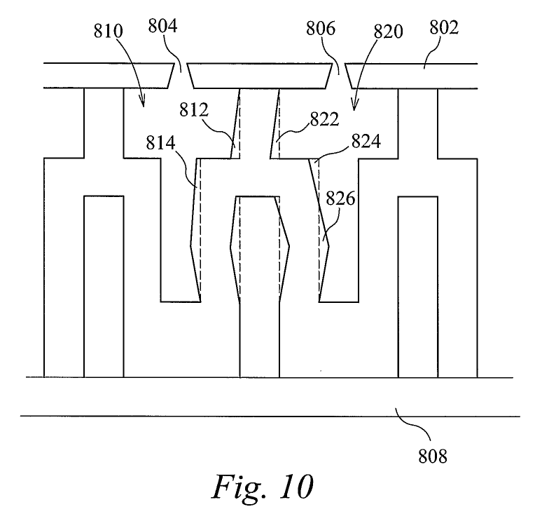

FIG. 10 illustrates the displaced configuration of the embodiment of FIG. 7;

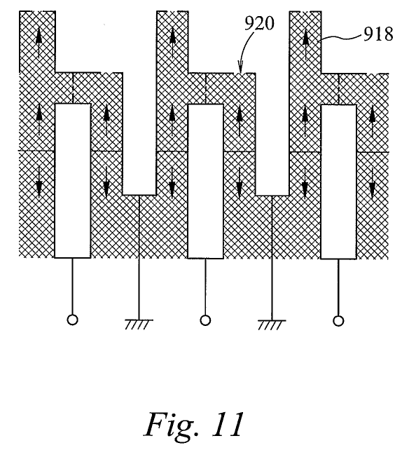

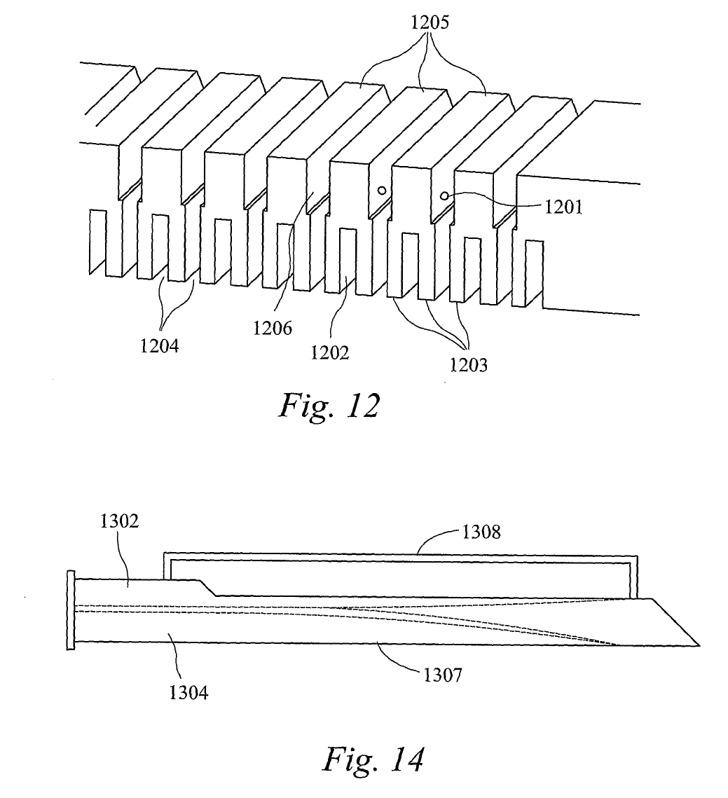

FIG. 11 shows a variation of the embodiment of FIG. 9;

FIG. 12 illustrates a further configuration;

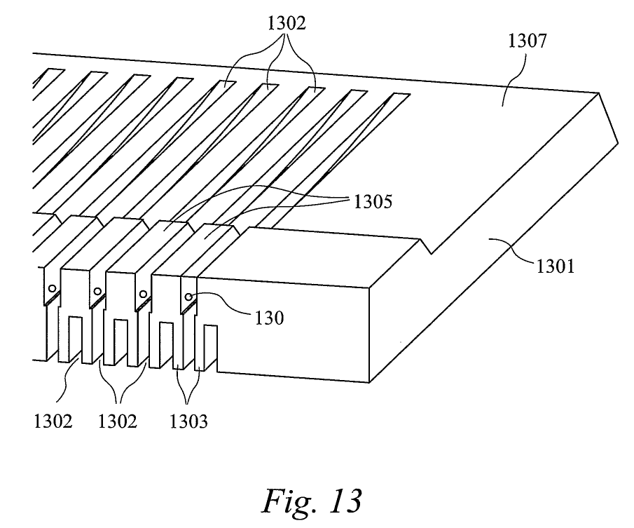

FIGS. 13 and 14 depict in transverse and longitudinal section a further embodiment; and

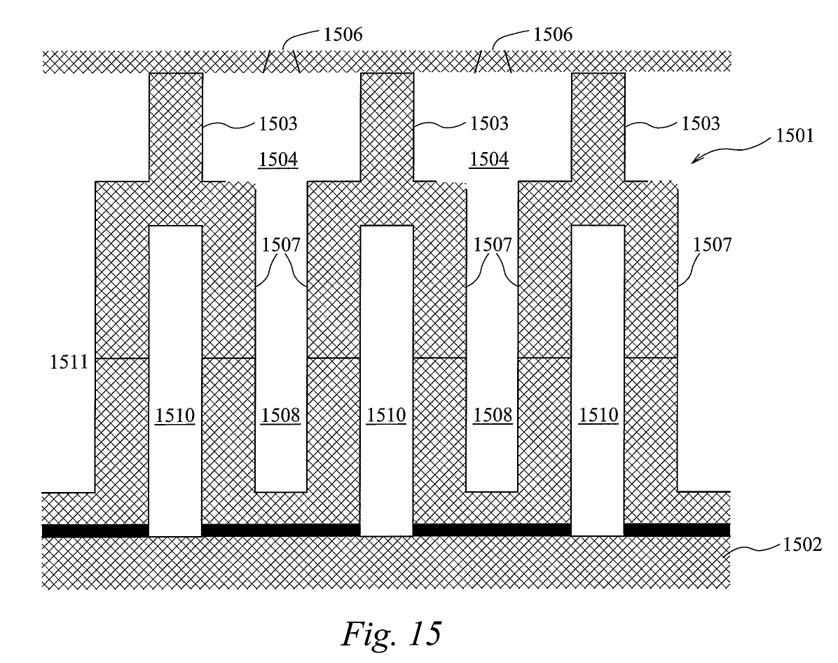

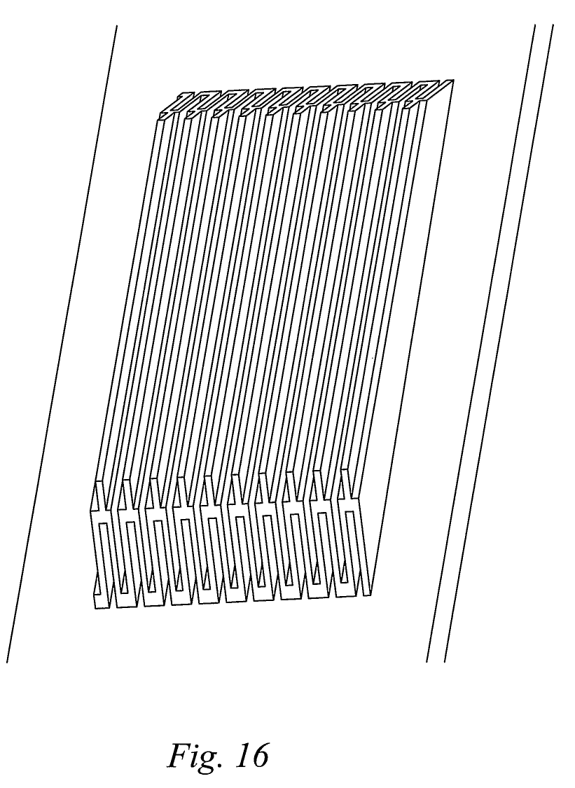

FIGS. 15 and 16 depict in transverse section and isometric view still a further embodiment.

Referring to FIG. 1, a known ink jet printhead arrangement comprises a plurality of ink channels 102 forming an array, in which the channels are spaced in an array direction and extend perpendicular to the array direction (into the page as viewed). The channels are formed in a body of piezoelectric material (in this case PZT) formed of an upper layer 104 and a lower layer 106. The two layers are poled in opposite directions as indicated by arrows 108 and 110. The channels are closed at the top and bottom by insulating sheets 112 and 114 respectively. The channels are lined with a metallic electrode layer 116. When an electric field is applied across a channel wall perpendicular to the direction of poling (through different voltages applied to the electrodes of the channels on either side of the channel wall), the wall is deflected in shear mode, and is displaced to adopt a chevron-like shape as shown schematically by broken lines 118. This in turn cases pressure changes in the channels bounded by that wall, which can be used to effect ink ejection from nozzles 120. It can be seen that ink is ejected from the ends of the channels, and this arrangement is known as an ‘end shooter’. Various firing sequences and patterns have been proposed to control droplet ejection for such a printhead arrangement.

FIG. 2 illustrates a known variation of the printhead shown in FIG. 1 in which the alternate channels are offset vertically. The nozzles 202 are arranged towards the bottom of upper channels 204 and towards the top of channels 206, so as to be arranged in substantially a straight line.

FIG. 3 shows a second type of known printhead arrangement in which a body of PZT 302 is formed with a plurality of open top channels 304. The channels are separated in an array direction by channel walls, each channel extending in a channel length direction perpendicular to the array direction. The channels are closed at the top surface by a nozzle plate 304, having formed herein a plurality of ejection nozzles 306. Electrodes (not shown) are formed on the channel walls, and by applying electric fields across the walls, they are caused to displace.

In operation, ink flows into the channels 304, preferably continuously from an inlet end of the channels 308 to an outlet end of the channels 310. Ink is ejected from selected channels by actuating the walls of those channels, the resulting pressure changes casing ejection from nozzles 306. This arrangement is known as a ‘side shooter’ and it can be seen that ink is ejected from the side of each channel, at a position intermediate its length.

Referring to FIG. 4, a first embodiment of the invention is shown schematically comprising a body of piezoelectric material (in this example PZT) having an array of channels. Alternate channels are offset vertically, channels 402 formed in the top surface of the PZT and being open, whilst channels 404 are formed lower in the PZT and are closed. Where the two sets of channels overlap, actuating sidewalls are defined with the PZT in these regions poled in opposite directions, as shown by arrows 406. These sidewalls are formed with electrodes and displace laterally under the influence of an electric field in shear mode, as described above. It can be seen that by activating the sidewalls, pressure changes can be caused in the channels, resulting in droplet ejection from nozzles (shown as broken lines 408) provided in a nozzle plate (not shown) bonded to the upper surface of the PZT and closing the upper channels.

The lower channels 404 are not formed with nozzles and are non-firing. In this example the non-firing channels are filled with ink and communicate with the ink supply manifold for the firing channels.

By offsetting the non-firing channels, tall thin firing channels—affording closer nozzle spacing while maintaining the cross sectional area of the channels—can be achieved without having similarly tall and thin channel walls which would suffer from low stiffness.

It is desirable that in certain embodiments the upper and lower channels are of similar cross sectional area. Dimensions and materials affecting the channel design can be chosen so that parameters contributing to the acoustic noise emitted into the manifold can be managed. One objective is the reduction of undesirable pressure waves in the manifolds, due to improved acoustic matching of the channels and therefore improved cancellation at the manifold, resulting in improved drop ejection characteristics.

A variation of the embodiment of FIG. 4 is shown in FIG. 5. Here the upper channels 502 are wider in the uppermost region than they are at their base, with a step formed part way down the channels. Alternatively, the channels could be tapered towards the base. This allows a more compact structure to be achieved where a certain equivalent hydraulic diameter, h_{D}, is necessary to provide the ink flow to the nozzle. A larger equivalent hydraulic diameter results in a smaller fluidic impedence such that in this respect the optimum form of the uppermost region is when its width (W) is equal to its height (H). For a square or rectangular channel section the hydraulic diameter, h_{D} is well known to be respresented as being equal to 4WH/(2W+2H).

In addition, the area of the channel surface with which the nozzle is to communicate is increased, allowing larger nozzles or even multiple nozzles to communicate with the upper channels.

The width (W) and height (H) dimensions should be chosen such that channel maintains a suitable stiffness, otherwise performance characteristics can be eroded. Typically, the channel width and height will be chosen such that the stiffness of the uppermost wall is similar to or greater than the stiffness of the lower actuating walls. As would be clearly understood by the skilled man, actual dimensions are only chosen after simulations are completed and where alternative designs, materials and performance compromises are taken into consideration.

A variation is illustrated in FIG. 6, where the array of side walls 604 separating the uppermost channel regions 602 are formed in a modified nozzle plate component 606. Similarly the array of side walls 604 could be formed in a nozzle support component underlying a “conventional” nozzle plate.

A cross section of a channel arrangement according to the present invention is shown in FIG. 7. From this figure it can be seen that the upper or firing channels have a substantially T-shaped cross section. A body of PZT is formed of two layers 602 and 604, poled in opposite directions as indicated by arrows 606. In a preferred method of manufacture, a metallic coating 608 is deposited on the inside of the channels to form electrodes on the channel walls. Electrical tracks 610 connect the electrodes to appropriate drive circuitry. A first set of tracks connecting to the lower channels 612 are connected to a common potential (of a fixed or varying amplitude), or ground. A second set of tracks connected to the upper channels 614, 616 are connected to drive nodes which can be selectively driven at a non zero potential. In this embodiment it is only necessary (from electrical considerations) to have active electrodes on the lower portions of the firing channels. However, certain metallic coatings can provide additional structural stiffness so that significant performance advantages can be made by maintaining a coating in specific regions, even where not necessary from electrical considerations.

To form electrodes corresponding to the two sets of tracks it is necessary to form a break in the metallic coating above the activating sidewalls, along the length of the channel. Because the stepped structure provides a step surface projecting in the array direction, this can conveniently be achieved by, for example, a laser cut onto the step surface as indicated by arrows 620.

The coating is also cut appropriately on the end faces of the body of PZT in order to separate the two sets of electrodes as indicated by lines 621 (not shown on FIG. 6a or 6b), which results in the coating on the uppermost wall portions 618 being connected to the first set of tracks (common or ground potential), the connection indicated by broken lines 622.

In order to operate, say, firing channel 614, node 624 is driven by a non-zero signal which results in a charge on the electrodes on the inside walls of upper channel 614 in the actuation region denoted 614′. This creates an electric field across the walls in this region, which displace into the channels in a chevron-like shape by virtue of the poling pattern as explained above. In the arrangement of FIG. 7, firing channels are driven symmetrically, actuable sidewalls on both sides of that channel in the actuating region deflecting into the channel.

The deflected shape is shown schematically in FIG. 8, which also shows a nozzle plate 650, having nozzles 652 and 654. The deflection of sidewalls 656 and 658 cause a longitudinal pressure wave in firing channel 614 which results in a droplet being ejected from nozzle 652 in the roof of the channel. Pressure changes also occur in non-firing channels 612, but have substantially no effect. Importantly, neighbouring firing channel 616 (and also the other neighbouring firing channel—not shown) remains substantially unaffected by the firing of channel 614. It is important to note that this firing operation for nozzle 652 provides a sequence of pressure changes to effect droplet ejection. The deflection of sidewall 658 (as shown in FIG. 8) generates a positive pressure into channel 614 and negative to 612. Regardless of the firing condition, the neighbouring channel 616 will receive a small negative pressure pulse through the compliance of the wall with 612. Similarly 616 will receive a pressure pulse in the uppermost region where it neighbours 614, except that this pressure will be positive. Careful design of the structure (e.g. consideration of relative wall compliances) allows operation wherein the neighbour-crosstalk (note: different to acoustic cross-talk in the manifold) substantially cancels.

In the arrangement of FIG. 7 there is no field across uppermost wall portions 618, and therefore these portions of PZT remain inactive and are non-actuable. In an alternative electrode arrangement, these uppermost portions can advantageously be made active as shown in FIG. 9.

In the arrangement FIG. 9, it is now the tracks connecting to the lower channels which accept drive signals, and the tracks connecting to the upper channels are kept at zero or earth potential. The cuts in the coating in this arrangement are made not on either shoulder of the upper channels, as in FIG. 7, but on one shoulder and on the top of the upper wall portions. The cutting on the end face indicated by lines 721 results in the electrodes on one side 740 of the upper wall portion being connected to zero potential, and those on the other side 742 being connected to the drive nodes, as indicated by broken lines 744.

Upon actuation of a drive node, say node 750, electric fields are set up across the inside walls of lower channel 752 in an actuation region. At the same time an electric field is set up across upper wall portion 754. This wall portion is also poled as indicated, and therefore this wall portion will displace in shear mode.

This field pattern results in equal outward deflections of the walls of lower channel 752, and a cantilever like deflection of the upper wall portion 754. The overall deflected shape is shown schematically in FIG. 10, which also shows a nozzle plate 802 closing the top of the upper channels and having nozzles 804, 806 and a base 808. The undeflected shape of the structure is shown in broken line. It can be seen that the deflection causes displacements at areas 812 and 814 in channel 810, both of which act to reduce the volume of the channel. At the same time the deflection cases displacements in channel 820 at areas 822 and 824 which increase the volume of this channel, but also a displacement at area 826 which decreases the volume of channel 820, thereby having a cancelling effect.

By selecting appropriate materials and dimensions, it will be understood that an arrangement can be produced whereby the displacements in channel 810 reinforce to provide an actuating pressure pulse, and whereby the displacements in channel 820 cancel to zero. Such an arrangement therefore allows firing in one upper channel to have substantially no pressure effect in the neighbouring upper channels.

FIG. 11 illustrates an embodiment of the invention in which the upper channels are not symmetrical. Upper wall portions 918, to which a cover or nozzle plate is to be attached are displaced in the array direction relative to the previous embodiment. It can be seen that the upper channels have a substantially (inverted) L-shaped configuration. This has the effect of producing a wider step surface in the upper channels, which presents a larger area for cutting of the coating to form electrodes, as depicted by arrow 920.

FIG. 12 illustrates an embodiment of the invention configured as an end-shooter device, that is to say the nozzles shown schematically at 1201 are arranged in a nozzle plate mounted to the open end of the firing channels 1202. The construction is otherwise similar to that shown in FIG. 5. A first array of actuable side walls 1203 define between them the channels which comprise the firing channels 1202 alternating with the non-firing channels 1204. A second array of sidewalls 1205 (which are not required to be actuable) are parallel with the actuable side walls 1203 and define between them extended channel regions 1206 for the respective firing regions. The nozzles 1201 communicate with these extended channel regions. Typically, a substrate (not shown) will carry the described actuator and a cover (not shown) attached to the uppermost surface of the actuator.

Other embodiments of the invention have the non-firing channels closed to the ink and filled with air so as to significantly reduce cross talk transmitted between neighbouring firing channels. Other compliant materials may be selected to completely or partially fill the non-firing channels.

FIGS. 13 and 14 illustrate such an alternative embodiment of the invention configured as an end-shooter device (although an arrangement of closed non-firing channels may also be advantageous to the side-shooter structures shown, for example, in FIG. 5.

In FIG. 13, a body of piezoelectric material 1301 has a forward region containing a first array of actuable side walls 1303 and a second parallel array of sidewalls 1305 (which are not required to be actuable). As in a previous, embodiment, the first array of actuable side walls 1303 define between the firing channels 1302 alternating with the non-firing channels 1304. The second parallel array of sidewalls 1305 define between them extended channel regions which communicate with the nozzles which are shown schematically at 1306 and which are arranged in a nozzle plate (not shown) mounted to the open end of the firing channels 1302.

The body of piezoelectric material 1301 also has a rearward region 1307. The firing channels 1302 extend into this rearward region 1307 to facilitate the supply of ink. An ink supply manifold , shown schematically at 1308 in FIG. 14 is provided for this purpose. FIG. 14 also shows how the firing channels (which are conveniently formed by sawing) run out to the upper surface of the body 1301. The non-firing channels 1304 are formed (by sawing) from the underside of the body 1301 and do connect communicate with the ink supply manifold 1308.

Reference is now directed to FIGS. 15 and 16, which illustrate a further embodiment of the present invention, in the side shooter configuration. As shown in FIG. 15, which is a section orthogonal to the length of the channels, a body of piezoelectric material 1501 is bonded to a substrate 1502. In this arrangement the body of piezoelectric material 1501 has an overall height of 545 μm.

The body 1501 provides an array of upper channel walls 1503, which between them define extended channel regions 1504 for the respective firing channels. A nozzle plate 1505 mounted to the upper surface of the body 1501 closes the firing channels and provides nozzles 1506.

The body 1501 also provides an array of actuable side walls 1507. The channels defined by these actuable side walls 1507 form, alternatively, firing channels 1508 and non-firing channels 1510. It will be seen that each firing channel 1508 opens to a respective channel extension region 1504. The actuable side walls 1507 are formed by upper and lower sections bonded at 1511; in known manner the upper and lower sections are poled in opposite directions so that the wall actuates in chevron sheer mode. The height of the actuating side wall is 300 μm providing (with the base section of the body 501 and the glue layer) a channel height for the non-firing channels of 375 μm. The width of the non-firing channels is 35 μm.

The electrodes shown at 1511 are connected broadly as described previously in relation to FIG. 7 although in this case the isolating break in the electrode structure is provided on one step only of the T-shape construction formed by the firing channel 1508 with its channel extension region 1504.

It is noted here that an advantage of this—and certain other of the described embodiments—is that the top surface of the piezoelectric body 1501 can remain metalised. The delicate and complex processing otherwise required to dress each wall top is avoided and the metallization may indeed simplify the forming of a bond to the nozzle plate (in a side shooter configuration) or the cover (in an end shooter configuration).

FIG. 16 shows the structure in isometric view with the nozzle plate removed for clarity. The end surfaces of the body 1501 are chamfered so as to enable these to be patterned with a laser beam normal to the substrate.

In use, ink flows, preferably continuously, through the firing channels with inlet and outlet ink manifolds being provided at opposite ends of the body 1501. The non-firing channels 1510 are in this arrangement open to the ink supply; it has been noted that in alternative configurations these non-firing channels can be filled with compliant material such as silicon rubber or closed from the ink and left open to the air.

Returning to FIG. 15, it can be seen how embodiments of the present invention can ingeniously meet two seemingly contradictory design requirements. To generate large pressure changes in a minimum volume, a channel would be required to be thin and to have thin walls. However, thin channels present high impedance to ink flow and do not easily allow the relatively high continuous flow rates through the channel that have been found previously to offer important advantages. The flow rate through the channel may for this reason be twice, five times or ten times the maximum flow rate through the nozzle on droplet ejection.

The arrangement shown in FIG. 15 addresses this problem. The thickness of the firing channels in the channel extension region 1504 is defined by the spacing between the walls 1503 and is relatively large. The channel extension regions 1504 therefore offer relatively low impedance to flow of ink along the length of the channel (that is to say out of the plane of the drawing in FIG. 15). However, the width of the firing channel in the actuation region is separately governed by the spacing of the actuating side walls 1507. In this arrangement, the spacing of the actuating side walls 1507 provides a channel width of 35 μm whilst the spacing of the non-actuating walls 1503 provide extended channel region thickness of 100 μm. The depth of the extended channel region 1504 occupies 120 μm of a total firing channel depth of 470 μm.

It should also be noted that whilst the wall thickness of the non-actuating side walls 1503 has been depicted as broadly the same as the wall thickness of the actuating side walls 1507, this is not a requirement and the thickness of the non-actuating walls 1503 can be adjusted in a particular application to balance the required width of the channel in the extended channel region 1504 and the required stiffness of the channel wall.

In a preferred arrangement, the channel extension region has an aspect ratio (being the larger of the ratio of the height to the width or the width to the height) of about 2 or less, more preferably about 1.5 or less, still more preferably about 1.2 or less.

In a preferred arrangement, the active region of each firing channel (being the region between the actuating sidewalls) channel extension region has an aspect ratio of about 3 or more, more preferably about 5 or more, still more preferably about 10 or more.

As has already been noted, the functional separation in each firing channel of an actuating region from an extended channel region also leads to the benefit that the different cross-talk effects in the actuating and extended channel regions of a neighbouring firing channel are in opposite senses so as to reduce considerably the cross-talk from one firing channel to the next.

Whilst this invention has been described taking as an example an ink jet printhead, it will be understood that the invention has more general application to droplet deposition apparatus.

The scope of the present disclosure includes any novel feature or combination of features disclosed herein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived herefrom. In particular, with reference to the appended claims, features from dependent claims may be combined with those of the independent claims and features from respective independent claims may be combined in any appropriate manner and not merely in the specific combinations enumerated in the accompanying claims.

1. Droplet deposition apparatus comprising an array of channels extending in a channel array direction, said channels extending in a channel length direction, wherein alternate channels in the array are displaced in an ink ejection direction orthogonal to the channel length direction and the array direction such that a first subset of said channels have top surfaces lying in an ink ejection plane perpendicular to the ink ejection direction, communicate with a droplet ejection nozzle in the ink ejection plane and are firing channels, and a second subset of said channels are spaced apart from said ink ejection plane and are non-firing channels, said first and second subsets of channels being separated by actuable sidewalls which are displaceable in the array direction to cause a pressure change in a selected channel thereby to effect droplet deposition from a selected ejection nozzle.

2. Droplet deposition apparatus according to claim 1, wherein the top surfaces of the firing channels are wider in the array direction than the bottom surfaces of the firing channels.

3. Droplet deposition apparatus according to claim 2, wherein a step is formed in sidewall surfaces abutting the firing channels to define for each firing channel an upper channel region, a lower channel region and a step surface, the upper channel region being wider than the lower channel region in the array direction.

4. Droplet deposition apparatus according to claim 3, wherein the step surface is substantially parallel to the ink ejection plane.

5. Droplet deposition apparatus according to claim 3, wherein the firing channels are substantially T-shaped in cross section.

6. Droplet deposition apparatus according to claim 3, wherein the firing channels are substantially L-shaped in cross section.

7. Droplet deposition apparatus according to claim 3, wherein the walls separating said upper channel portions of said first subset of channels are non-actuable.

8. Droplet deposition apparatus comprising: a first array of actuable side walls extending in an array direction to define therebetween respective channels, said side walls and said channels extending in a channel length direction, the actuable sidewalls being displaceable in the array direction to cause a pressure change in selected channels, wherein alternate channels in the array are firing channels; a second array of side walls extending parallel with the first array of actuable side walls and offset with respect to the first array in a channel height direction orthogonal to the channel length direction and the array direction to define therebetween respective channel extension regions, each channel extension region opening to a respective firing channel; a droplet ejection nozzle communicating with each channel extension region, such that actuation of the two actuable side walls of a firing channel effects droplet deposition from the droplet ejection nozzle in the channel extension region of that firing channel; wherein the spacing between adjacent side walls in the second array is greater than the spacing between adjacent actuable side walls in the first array.

9. Droplet deposition apparatus according to claim 8, wherein each channel extension region has an aspect ratio of about two or less.

10. Droplet deposition apparatus according to claim 8, wherein each channel region between adjacent actuable sidewalls has an aspect ratio of about five or more.

11. Droplet deposition apparatus according to claim 8, wherein the actuable sidewalls are formed of piezoelectric material.

12. Droplet deposition apparatus according to claim 8, wherein the direction of droplet ejection from the firing channel is parallel to the length of each channel.

13. Droplet deposition apparatus according to claim 8, wherein the direction of droplet ejection from the firing channel is orthogonal to the length of each channel.

14. Droplet deposition apparatus according to claim 8, having an electrode layer extending over a channel facing surface of side wall wall, a step in said sidewall forming the location for an electrically isolating break in said electrode layer.

15. Droplet deposition apparatus according to claim 8, configured for the continuous flow of droplet deposition fluid along each firing channel.

16. Droplet deposition apparatus comprising an array of channels extending in a channel array direction, said channels extending in a channel length direction, wherein alternate channels in the array are displaced in a channel height direction orthogonal to the channel length direction and the array direction such that a first subset of said channels have top surfaces lying in a top plane perpendicular to the channel height direction, and a second subset of said channels are spaced apart from said top plane; said first and second subsets of channels being separated by actuable sidewalls which are displaceable in the array direction to cause a pressure change in a selected channel thereby to effect droplet deposition; and wherein a step is formed in the sidewalls of said first subset of channels defining an upper channel portion, a lower channel portion and a step surface, the upper channel portion being wider than the lower channel portion in the array direction.

17. Droplet deposition apparatus according to claim 16, wherein the step surface is substantially parallel to the ink ejection plane

18. Droplet deposition apparatus according to claim 16, wherein said first subset of channels are substantially T-shaped in cross section.

19. Droplet deposition apparatus according to claim 16, wherein said first subset of channels are substantially L-shaped in cross section.
